(19) United States
(12) Patent Application Publication
(10) Pub. No.: US 2007/0136678 A1
(43) Pub. Date: Jun. 14, 2007

(54) Software process and method that allows a computer program to run in memory, but display as a digital graphic or text window

(76) Inventors: Michael Wayne Brown, Burlington, WA (US); Alan Charles Looff, Bellingham, WA (US)

Correspondence Address: Michael Brown, Suite H, 74-381 Kealakehe Pkwy, Kailua Kona, HI, 96740, US

(21) Appl. No.: 11/604,092

(22) Filed: Nov. 24, 2006

Related U.S. Application Data
(60) Provisional application No. 60/739,488, filed on Nov. 23, 2005.

(51) Int. Cl. G06F 3/00; G06F 17/00

(52) U.S. Cl. 715/771; 715/764; 715/772

(57) ABSTRACT

A software system and/or invention that allows a computer program to run in memory, but display as an icon or other digital graphic and/or a text window, also referred to as a minimized graphic. The software system allows the user to quickly and easily enable or disable a program to run in memory as a minimized graphic, or in a normal operating mode/normal display format, providing a number of advantages, including allowing the user to maintain visual privacy of their running program and computer display.

### OBJECTS

An object of the software invention is to allow a computer program to run in memory, but display as an icon or other digital graphic and/or a text window, also referred to as a minimized graphic.

Another object of the software invention is to allow the user to quickly and easily enable or disable a program to run in memory as a minimized graphic, or in a normal operating mode/normal display format.

Another object of the software invention is to allow a computer program to run in memory as a minimized graphic, but to also allow quick, efficient and/or intermittent viewing of the program in a normal display format by using a combination of one or more keyboard key(s), pointing movement(s) or other input device(s).

Another object of the software invention is to allow the user to maintain visual privacy of their running program and computer display by running the program in memory as a minimized graphic.

Another object of the software invention is to is allow the user to maintain a clean desktop display by running a program as a minimized graphic, without incurring the additional effort required to ‘minimize’ or ‘maximize’ the program every time it is desirable to view the program in a normal display format.

### RELEVANT PRIOR ART

A preliminary search found no prior art at this time.

### OTHER REFERENCES AND PUBLICATIONS

None provided at this time.

### BACKGROUND

Joint design and development of the invention began in 2004 by the above referenced individuals. The conceptual aspects and basic program control parameters were conceived to allow a more practical method of allowing a user to continuously run a computer program, but simultaneously reduce the running program to display as a digital graphic and/or text window. This is particularly useful with any type of software utility program that would be intermittently and/or periodically viewed or accessed by the user.

The inventors are unaware of any other of any other software programs on the market that includes the embodiments of this software utility.

### ADVANTAGES

One advantage of the software invention is that is allows a computer program to run in memory, but display as an icon or other digital graphic and/or a text window, also referred to as a minimized graphic.

Another advantage of the software invention is that it allows the user to quickly and easily enable or disable a program to run in memory as a minimized graphic, or in a normal operating mode/normal display format.

Another advantage of the software invention is that it allows a computer program to run in memory as a minimized graphic, but also allows the user to quickly, efficiently and/or intermittently view the program in a normal display format by using a combination of one or more keyboard key(s), pointing movement(s) or other input device(s).

Another advantage of the software invention is that is allows the user to maintain visual privacy of their running program and computer display by running the program in memory as a minimized graphic, essentially allowing the user to quickly display or quickly hide the running program display.

Another advantage of the software invention is that is allows the user to maintain a clean desktop display by running a program as a minimized graphic, without incurring the additional effort required to ‘minimize’ or ‘maximize’ the program every time it is desirable to view the program in a normal display format.

### BRIEF DESCRIPTION OF THE DRAWINGS—FIGURES

The drawing figures constitute a part of this specification and include exemplary embodiments of the invention in the present configuration, which may also be embodied in other various forms and configurations.

FIG. 1 shows an object interaction map of the software invention in the present configuration.

FIG. 2 shows an example screenshot of a typical computer display with a sample utility program (Stock-Trac v1.0.0) running in a normal operating mode/normal display format.

FIG. 3 shows an example screenshot of the same typical computer display with the same sample utility program (Stock-Trac v1.0.0) running in a normal operating mode/normal display format, with the ‘View’ drop down menu selected and the curser positioned over the ‘Minimize to Graphic’ menu item for selection.

FIG. 4 shows an example screenshot of the same typical computer display with the same sample utility program (Stock-Trac v1.0.0) running in the minimized to graphic mode, selected from the ‘View’ drop down menu, with the mouse curser LOCATED OFF of the graphic.

FIG. 5 shows an example screenshot of the same typical computer display with the same sample utility program (Stock-Trac v1.0.0) running in the minimized to graphic mode, with the mouse curser MOVED ONTO the graphic which concurrently activates the normal display format.

FIG. 6 shows an example screenshot of the same typical computer display with the same sample utility program (Stock-Trac v1.0.0) running in a normal operating mode/normal display format, immediately after the curser is MOVED ONTO the graphic and the mouse right-clicked, which disables the minimized to graphic mode and enables display of the program only in the normal operating mode/normal display format.

### BRIEF DESCRIPTION OF THE DRAWINGS—REFERENCE MUMERALS

The reference numerals on the drawing figures correspond with the detailed description of the program components included in the following section. 10—sample utility program normal display format 12—curser 14—sample utility program ‘View’ menu 16—sample utility program ‘View’ drop down menu 18—sample program ‘Minimize to Graphic’ drop down menu option 20—sample program minimized to graphic

### DESCRIPTION AND OPERATION

Detailed descriptions of the preferred embodiments have been provided herein. It is to be understood, however, that the present invention may be embodied in various forms. Therefore, specific details disclosed herein are not interpreted to be limiting, but rather as a basis for teaching one skilled in the art to employ the present invention in virtually any appropriately detailed system, structure, or manner.

The program can be coded in various programming languages and formats, but is the current embodiment has been coded in Visual Basic 6.0.

The operation of the program is described in three different manners as follows: (1) Narrative Description, (2) Object Interaction Map, and (3) Printed Source Code.

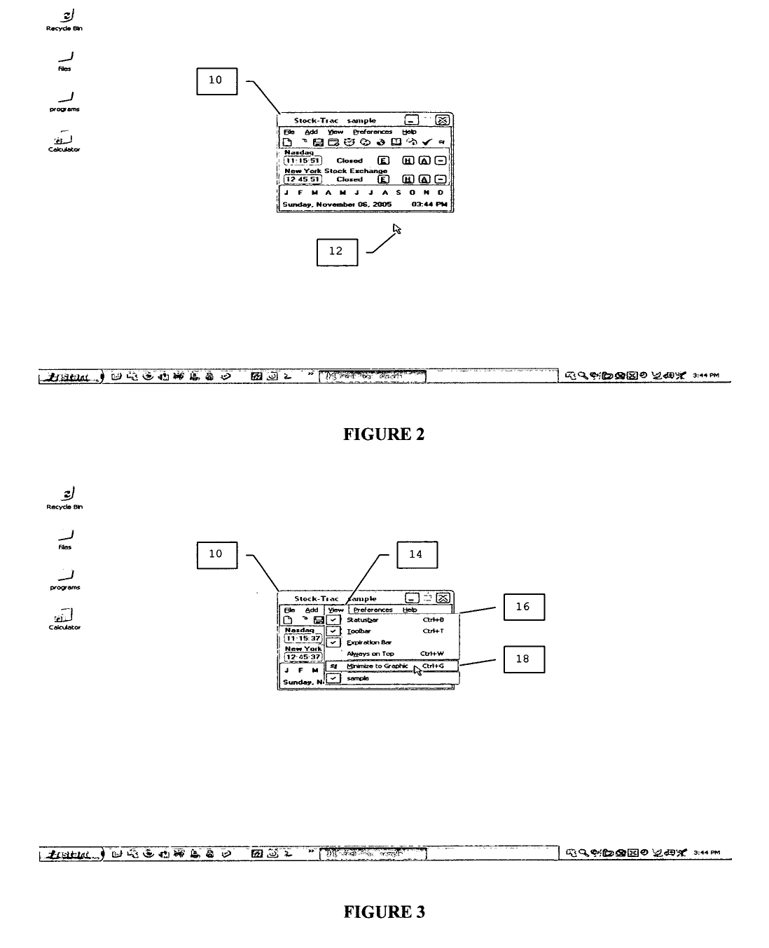

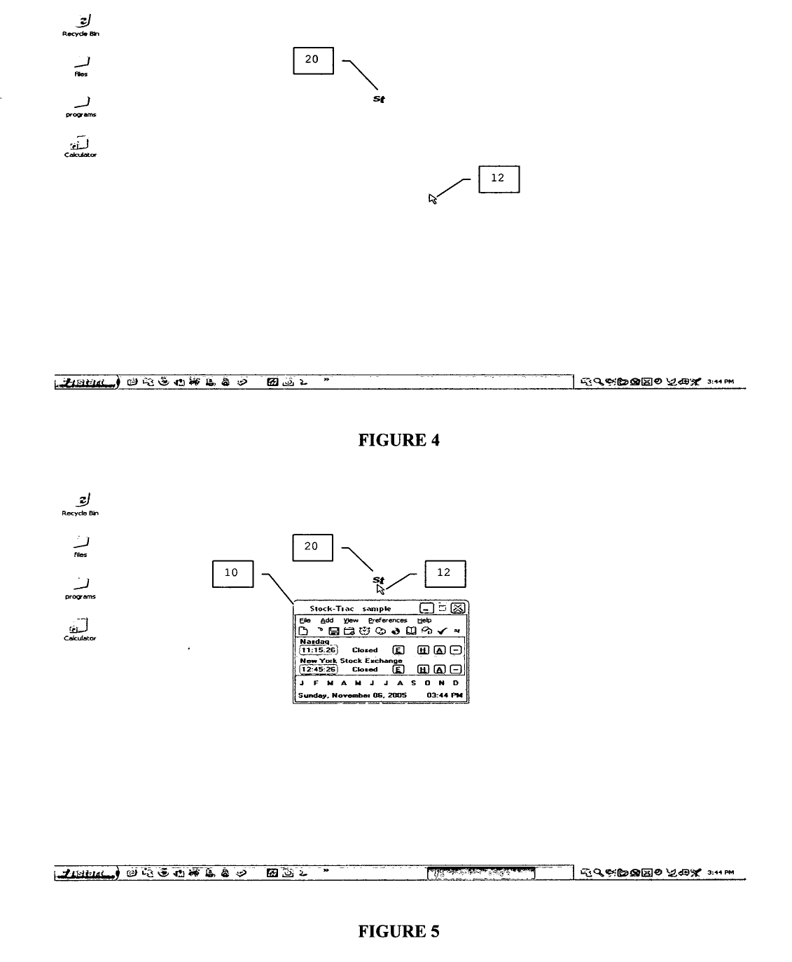

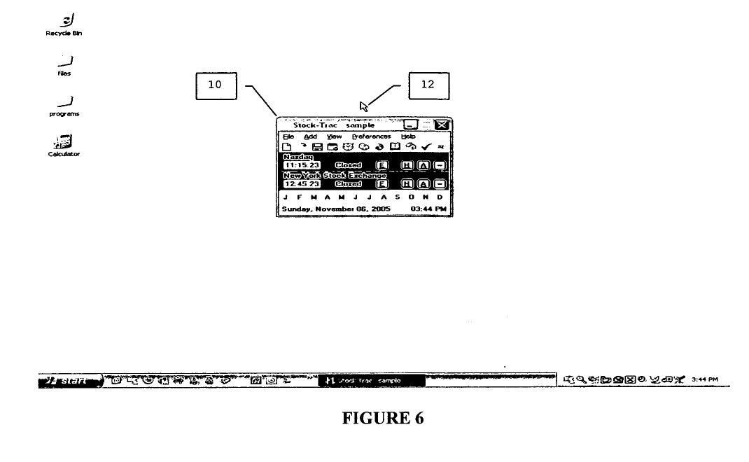

(1) Narrative Description: Refer to FIGS. 2, 3, 4, 5 and 6 along with the following narrative description. In normal operation a computer program will run in a standard operational mode and display on the computer monitor in a normal display format 10, as shown in FIG. 2. As shown in FIG. 3, in it's current configuration the running software program is minimized to a graphic 20 by selecting the program ‘View’ menu 14, and then scrolling down and selecting the ‘Minimize to Graphic’ 18 option from the drop down menu 16. As shown in FIG. 4, the running program then minimizes to a graphic 20, such that the program is still running in memory, but is not visible in a normal display format 10. As shown in FIG. 5, the normal display format 10 can be intermittently and/or periodically viewed or accessed by the user by moving the curser 12 onto the graphic 20. As shown in FIG. 6, the normal display format 10 can be permanently restored by right clicking the mouse or utilizing other hot key commands.

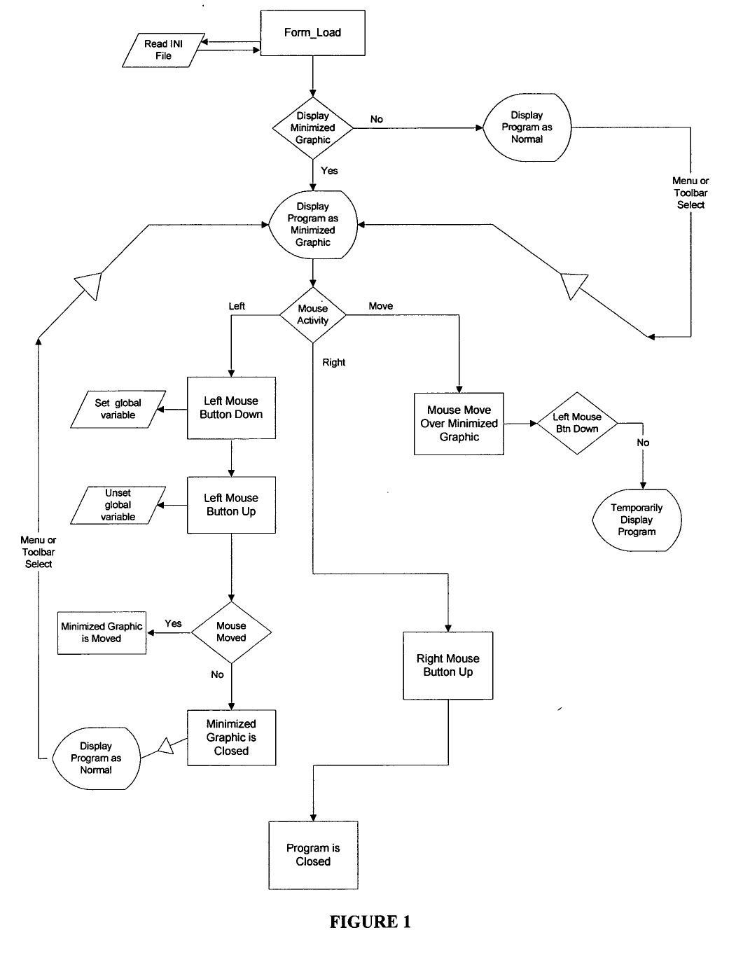

(2) Object Interaction Map: To describe the best mode of operation of the software invention in the current embodiment refer to the visual Object Interaction Map shown in FIG. 1, in conjunction with following description.

Introduction— The code for the Minimize to Graphic functionality is contained in one additional module. There are several functions that need to interface with other areas of the program, as outlined below. The functions fall into three different groups:

i. Functions that need to interface with main program startup and close.

ii. Functions that need to interface with main program menu and toolbar functions.

iii. Core functions for the Minimized Graphic.

After the text explanation below, there is a visual object interaction map that displays the basic functionality of the Minimized Graphic.

i. Functions that Need to Interface with Main Program Startup and Close:

ProgramStartup— This function is called when the program first starts up. The INI file is read to determine if the program should display its main window or the Minimized Graphic. This function needs to be interfaced with the main program and is typically called from the Main( ) function in the program.

Form₁₃Unload— This function is called when the program closes. The last position of the Minimized Graphic is saved to the INI file. The timer is stopped. This function needs to be interfaced with the main program and called from the unload function for the main program.

ii. Functions that Need to Interface with Main Program Menu and Toolbar Functions:

MenuMinToGraphic— This function is called to determine if the “Minimize to Graphic” option is selected on the main menu. The selection is saved in the INI file. This function needs to be interfaced with the main program and is typically called from the main form code where menu functions are handled.

ManuGraphicAlwaysOnTop—This function is called to determine if the “Always on Top” option is selected on the main menu for the Minimized Graphic. This function needs to be interfaced with the main program and is typically called from the main form code where menu functions are handled.

ToolbarClick—This function is called when the “Minimize to Graphic” toolbar button has been clicked. The main window is hidden and the Minimized Graphic then shows. This function needs to be interfaced with the main program and is typically called from the main form code where toolbar functions are handled.

PositionToobarIcon—This function is called to reposition the “Minimize to Graphic” toolbar button to the extreme right edge on the toolbar. This function needs to be interfaced with the main program and called when the main window (and hence toolbar) is resized.

iii. Core Functions for the Minimized Graphic:

Form_Load—Loads the Minimized Graphic form, positions it and sizes it properly. The position is based on the last position saved in the INI file. Or if have first use of program, is set to a default position on the screen. Also, the position excludes certain areas, such as being beneath the main window of the application.

GlassifyFormCorners—This function is called to smooth the square corners of the Minimized Graphic icon and make the corners round, so that the Graphic appears as a circle.

SetGraphicNotUnderWindow—This function is called to make sure that the Minimized Graphic icon is not located under the main window.

ShowAgain—This function is called when it is desired to show the Minimized Graphic. If the “Always on Top” option is in effect, then that capability is enabled. The timer is started.

Imagel_MouseDown—This function is called when a mouse button is clicked down. If the left button was clicked, then the position of the Minimized Graphic is changed slightly so that the mouse cursor is in the center. A global variable is set to indicate that the left mouse button is down, and this variable is used during mouse move operations.

Imagel_MouseMove—This function is called when the mouse moves. If the left mouse button is down (based on the global variable), then the position of the Minimized Graphic is repositioned to where the mouse cursor is currently located. If the left mouse button is not down (based on the global variable), then the main window is shown (while mouse cursor is over Minimized Graphic).

Imagel_MouseUp—This function is called when a mouse button comes up. If the left button came up, and if no mouse movement occurred, then the Minimized Graphic is closed and the main window is shown. If the right button came up, then the Minimized Graphic form is unloaded and the application closes.

trmIcon_Timer—This function is called by the system every 250 milliseconds. If the Minimized Graphic is visible and the cursor is not located over the Minimized Graphic, then the main window is hidden.

(3) Printed Source Code: To further describe the best mode of operation of the software invention in the current embodiment a copy of the printed source code or object code is as follows.

MinGraphicCode_{—}093005 R1.txt

′ COPYRIGHT © 2004-2005 FUTURESTRAC© LLC. ALL RIGHTS RESERVED. NOT TO BE REPRODUCED OR TRANSMITTED IN ANY FORM.

Option Explicit
Dim iClick As Integer
Dim lngImgCursorLeft As Long
Dim lngImgCursorTop As Long
Dim lngImgOrigLeft As Long
Dim lngImgOrigTop As Long
Dim intExamineGraphicPosn As Integer
Dim blnFirstMainShow As Boolean
Private Type PointStruc
X As Long
Y As Long
End Type
Private Type RectStruc

Left As Long
Top As Long
Right As Long
Bottom As Long

End Type
Private Declare Function GetCursorPos Lib ″user32″ (ptPoint As PointStruc) As Long
Private Declare Function GetWindowRect Lib ″user32″ (ByVal hWnd As Long, rcRect As
Rectstruc) As Long
Private Declare Function BringWindowToTop Lib ″user32″ (ByVal hWnd As Long) As Long
Private Declare Function SetForegroundWindow Lib ″user32″ (ByVal hWnd As Long) As Long
Private Declare Function SetWindowRgn Lib ″user32″ (ByVal hWnd As Long, ByVal hRgn As Long,
ByVal bRedraw As Long) As Long
Private Declare Function CreateRoundRectRgn Lib ″gdi32″ (ByVal nLeftRect As Long, ByVal
nTopRect As Long, ByVal nRightRect As Long, ByVal nBottomRect As Long, ByVal nWidthEllipse
As Long, ByVal nHeightEllipse As Long) As Long
′ Load the form.
Private Sub Form_Load ( )

Dim Temp As Variant
With frmMinGraphic

.Move Screen.Width / 2 - .Width / 2, Screen.Height / 2 - .Height / 2

End With
′ Position the image to the top left of the window.
frmMinGraphic.Image1.Left = 0
frmMinGraphic.Image1.Top = 0
′ Size the window to the same size as the image.
frmMinGraphic.Width = fnnMinGraphic.Image1.Width
frmMinGraphic.Height = frmMinGraphic.Image1.Height
Temp = FindINIValue(″Mt.ini″, ″MinGraphic_FirstUse″)
If Temp(0) = True Then

SetGraphicNotUnderWindow
Call StuffINIValue(″Mt.ini″, ″MinGraphic_FirstUse″, ″False″)

Else

Temp = FindINIValue(″Mt.ini″, ″MinGraphic_{— Left″, ″MinGraphic}_Top″)
frmMinGraphic.Left = Temp (0)
frmMinGraphic.Top = Temp (1)

End If
′ Hide the corners of the form, so minimized graphic looks round.
GlassifyFormCorners

End Sub
′ Do not allow the graphic to be placed under the main window.
Private Sub SetGraphicNotUnderWindow( )

Dim lngRtn As Long
Dim rect As RectStruc
Dim lngTwipsX As Long
Dim lngTwipsY As Long
Dim lngMargin As Long
Dim frmMinGraphicRight As Integer
Dim frmMinGraphicBottom As Integer
Dim lngLeftPosn As Long
Dim lngRightPosn As Long
Dim lngTopPosn As Long
Dim lngBtmPosn As Long
lngTwipsX = Screen.TwipsPerPixelX
lngTwipsY = Screen.TwipsPerPixelY
lngRtn = GetWindowRect (fMainForm.hWnd, rect)
rect.Bottom = rect.Bottom * lngTwipsY
rect.Left = rect.Left * lngTwipsX
rect.Right = rect.Right * lngTwipsX
rect.Top = rect.Top * lngTwipsY
frmMinGraphicRight = frmMinGraphic.Left + frmMinGraphic.Width
frmMinGraphicBottom = frmMinGraphic.Top + frmMinGraphic.Height
lngMargin = frmMinGraphic.Width / 3
lngLeftPosn = frmMinGraphic.Left - rect.Left
lngRightPosn = rect.Right - frmMinGraphicRight
lngTopPosn = frmMinGraphic.Top - rect.Top
lngBtmposn = rect.Bottom - frmMinGraphicBottom
If (frmMinGraphic.Left > rect.Left - lngMargin) And (frmMinGraphicRight < rect.Right +

lngMargin) And _{—}

(frmMinGraphic.Top > rect.Top - lngMargin) And (frmMinGraphicBottom < rect.Bottom +

lngMargin) Then

If (lngLeftPosn <= lngRightPosn) And (lngLeftPosn <= lngTopPosn) And (lngLeftPosn <=

lngBtmPosn) Then

If rect.Left > frmMinGraphic.Width Then

frmMinGraphic.Left = rect.Left - frmMinGraphic.Width

Else

frmMinGraphic.Left = rect.Right

End If

ElseIf (lngRightPosn < lngLeftPosn) And (lngRightPosn < lngTopPosn) And (lngRightPosn

< lngBtmPosn) Then

If Screen.Width - rect.Right > frmMinGraphic.Width Then

frmMinGraphic.Left = rect.Right

Else

frmMinGraphic.Left = rect.Left - frmMinGraphic.Width

End If

ElseIf (lngTopPosn <= lngLeftPosn) And (lngTopPosn <= lngRightPosn) And (lngTopPosn

<= lngBtmPosn) Then

If rect.Top > frmMinGraphic.Height Then

frmMinGraphic.Top = rect.Top - frmMinGraphic.Height

Else

frmMinGraphic.Top = rect.Bottom

End If

ElseIf (lngBtmPosn <= lngLeftPosn) And (lngBtmPosn <= lngRightPosn) And (lngBtmPosn

<= lngTopPosn) Then

If Screen.Height - rect.Bottom > frmMinGraphic.Height Then

frmMinGraphic.Top = rect.Bottom

Else

frmMinGraphic.Top = rect.Top - frmMinGraphic.Height

End If

End If

End If

End Sub
Public Sub ShowAgain( )

If Me.tmrIcon.Enabled = False Then

Me.tmrIcon.Enabled = True

End If
Show
′ The minimized graphic is always on top.
SetWindowPos frmMinGraphic.hWnd, hWnd_TOPMOST, frmMinGraphic.Left / 15,

frmMinGraphic.Top / 15, frmMinGraphic.Width / 15, _{—}

frmMinGraphic.Height / 15, SWP_NOACTIVATE Or SWP_SHOWWINDOW

End Sub
Public Sub ProgramStartup( )

blnFirstMainShow = True
MenuMinToGraphic

End Sub
Public Sub PositionToolbarIcon( )

′ If toolbar can be resized and has the MinToGraphic icon, will need to reposition the

icon.
End Sub
Public Sub MenuMinToGraphic( )

frmMinGraphic.ShowAgain
fMainForm.Hide

End Sub
Public Sub MenuGraphicAlwaysOnTop( )

SetWindowPos frmMinGraphic.hWnd, hWnd_TOPMOST, frmMinGraphic.Left / 15, _{—}

frmMinGraphic.Top / 15, frmMinGraphic.Width / 15, _{—}
frmMinGraphic.Height / 15, SWP_NOACTIVATE Or SWP_SHOWWINDOW

End Sub
Public Sub ToolbarClick ( )

frmMinGraphic.ShowAgain
fMainForm.Hide

End Sub
Public Sub Form_Unload(Cancel As Integer)

If fMainForm.WindowState <> vbMinimized Then

Call StuffINIValue(″Mt.ini″, ″MinGraphic_Left″, frmMinGraphic.Left)
Call StuffINIValue(″Mt.ini″, ″MinGraphic_Top″, frmMinGraphic.Top)

End If

Me.tmrIcon.Enabled = False
If (Cancel = 1) Then

Unload fMainForm

End If
Unload Me

End Sub
Private Sub Image1_Click( )

Dim intTest As Integer
intTest = intTest + 1

End Sub
Private Sub Image1_MouseDown(Button As Integer, Shift As Integer, X As Single, Y As Single)

If Button = 1 Then

iClick = 1
lngImgCursorLeft = X
lngImgCursorTop = Y
lngImgOrigLeft = frmMinGraphic.Left
lngImgOrigTop = frmMinGraphic.Top

End If

End Sub
Private Sub Image1_MouseMove(Button As Integer, Shift As Integer, X As Single, Y As Single)

Dim lngTempLeft As Long
Dim lngTempTop As Long
If iClick = 1 Then

frmMinGraphic.Left = frmMinGraphic.Left + X − lngImgCursorLeft
frmMinGraphic.Top = frmMinGraphic.Top + Y − lngImgCursorTop

Else

If fMainForm.Visible = False Then

ShowMainForm
fMainForm.SetFocus
BringWindowToTop (fMainForm.hwnd)
SetForegroundWindow (fMainForm.hWnd)

End If

End If

End Sub
Private Sub ShowMainForm( )

If blnFirstMainShow = True Then

blnFirstMainShow = False
MTCommon.MainFormInit

End If
fMainForm.Show

End Sub
Private Sub Image1_MouseUp(Button As Integer, Shift As Integer, X As Single, Y As Single)

If (Button = 1) And (iClick = 1) Then

If (frmMinGraphic.Left = lngImgOrigLeft) And (frmMinGraphic.Top = lngImgOrigTop) Then

frmMinGraphic.Form_Unload (0)
ShowMainForm

Else

SetGraphicNotUnderWindow

End If

ElseIf Button = 2 Then

frmMinGraphic.Form_Unload (1)

End If
iClick = 0

End Sub
Private Sub tmrIcon_{— Timer( )}

Dim point As PointStruc
Dim rect As RectStruc
Dim lngRtn As Long
If fMainForm.Visible = True Then

lngRtn = GetCursorPos(point)
lngRtn = GetWindowRect(frmMinGraphic.hWnd, rect)
If (point.X < rect.Left) Or (point.X > rect.Right) Or _{—}
(point.Y < rect.Top) Or (point.Y > rect.Bottom) Then

fMainForm.Hide

End If

End If
′ Check that the graphic is not under the main window (when left button is not down).
If iClick <> 1 Then

′ Is not necessary to examine graphic position every time.
If intExamineGraphicPosn > 5 Then

intExamineGraphicPosn = 0
Call SetGraphicNotUnderWindow

Else

intExamineGraphicPosn = intExamineGraphicPosn + 1

End If

End If

End Sub
′ Hide the corners of the form, so minimized graphic looks round.
Public Sub GlassifyFormCorners( )

Dim sngWidth As Single
Dim sngHeight As Single
Dim lngRoundRegion As Long
If WindowState = vbMinimized Then

Exit Sub
End If

′ Create the main form region, with rounded corners.
sngwidth=ScaleX(Width, vbTwips, vbpixels)
sngHeight=ScaleY(Height, vbTwips, vbpixels)
lngRoundRegion=CreateRoundRectRgn(0, 0, sngwidth, sngHeight, sngWidth, sngHeight)
′ Restrict the window to the region.
Call SetWindowRgn(hWnd, lngRoundRegion, True)

End Sub

′ COPYRIGHT © 2004-2005 FUTURESTRAC© LLC. ALL RIGHTS RESERVED. NOT TO BE TRANSMITTED OR REPRODUCED IN ANY FORM.

While the invention is described in connection with the current embodiment, it is not intended to limit the scope of the invention to the particular form set forth, but on the contrary, it is intended to cover such alternatives, modifications, additions, and equivalents as may be included within the spirit and scope of the invention.

### ALTERNATIVE EMBODIMENT

The current embodiment of the software invention allows a single computer program to run in memory, but graphically display as an icon or other small digital graphic and/or text window (minimized graphic).

(1) Alternative embodiment as an OCX control

The minimized graphic functionality could be put into a separate program called an OCX (OLE Custom Control) that has a predefined interface. An OCX control is also commonly called an ActiveX control and has a standard CCM (Component Object Model) interface. This would make it easy for other programs to use the minimized graphic functionality. Through its interface, the OCX control exposes functions that can be called by the main program. Every aspect of the minimized graphic could be controlled, to give it the same functionality that it has in the sample program Stock-Trac.

(2) Alternative embodiment where the minimized graphic is a separate application that runs a single program.

The minimized graphic could be coded as a separate, stand-alone program. It would not be an OCX control and would not have a CCM interface. It would not directly integrate with another program. Rather, it would run as a completely separate program and send Windows messages to the main program that desires minimized graphic functionality. A configuration feature present in the minimized graphic program would be used to specify the name of the main program. When the mouse cursor is moved over the minimized graphic, the main program would be brought to the front of other programs. This basic functionality could be achieved with no modification to the main program. If additional minimized graphic functionality is desired, functions could be added to the main program. The minimized graphic program would call these functions by sending Windows messages to the main program.

(3) Alternative embodiment where the minimized graphic is a separate application that runs multiple programs.

The minimized graphic could be a separate, stand-alone program that controls multiple programs. When the mouse is moved over the minimized graphic, a menu would drop down with a list of programs that could be brought to the forefront. A configuration feature present in the minimized graphic program would be used to specify the names of the main programs. If additional minimized graphic functionality is desired, functions could be added to the main programs. The minimized graphic program would call these functions by sending Windows messages to the main programs.

(4) In another alternate embodiment the actively operating minimized graphic icon could be set as transparent, hidden, or to appear hidden on the computer display using a combination of one or more keyboard key(s), pointing movement(s) or other input device(s), but still maintain the functionality and functional aspects for display of the program(s)or application(s) running in memory.

(5) In another alternative embodiment the software invention could include a function that would allow the program(s) to initially start and/or open as a minimized graphic.

(6) In another alternative embodiment the software invention could include a function that would allow the program to minimize to the desktop, system tray or task bar.

(7) In another alternative embodiment the software invention could include a function that would allow the minimized graphic to function as, or pass through, a visual or audible alert from the program running in memory.

(8) In another alternative embodiment any of the functions, features, or above noted alternative embodiments of the minimized graphic could be modified and/or applied to any electronic or portable computing device, PDA or personal information management device, or other electronic devices or displays.

Many other variations and embodiments of the software invention, display format, user interface and configuration of controls are possible and would, essentially, include the addition, modification, deletion, variation and/or any combination of the presented information and program components.

What is claimed is:

1) A software system and/or invention that allows a computer program to run in memory, but display as an icon or other digital graphic and/or a text window, also referred to as a minimized graphic.

2) A software system and/or invention as recited in claim 1 that allows the user to quickly and easily enable or disable a program to run in memory as a minimized graphic, or in a normal operating mode/normal display format.

3) A software system and/or invention as recited in claim 1 that allows a computer program to run in memory as a minimized graphic, but also allows the user to quickly, efficiently and/or intermittently view the program in a normal display format by using a combination of one or more keyboard key(s), pointing movement(s) or other input device(s).

4) A software system and/or invention as recited in claim 1 that allows the user to maintain visual privacy of their running program and computer display by running the program in memory as a minimized graphic, essentially allowing the user to quickly display or quickly hide the running program display.

5) A software system and/or invention as recited in claim 1 that allows the user to maintain a clean desktop display by running a program as a minimized graphic, without incurring the additional effort required to ‘minimize’ or ‘maximize’ the program every time it is desirable to view the program in a normal display format.
